(19) United States
(12) Patent Application Publication
(10) Pub. No.: US 2015/0319634 A1
(43) Pub. Date: Nov. 5, 2015

(54) ACQUIRING INFORMATION REGARDING A VOLUME USING WIRELESS NETWORKS

(71) Applicant: Gil Zwirn, Petah Tikva (IL)

(72) Inventor: Gil Zwirn, Petah Tikva (IL)

(21) Appl. No.: 14/434,407

(22) PCT Filed: Sep. 17, 2013
(86) PCT No.: PCT/IB2013/058620

§ 371 Date: Apr. 9, 2015

(30) Foreign Application Priority Data
Oct. 18, 2012 (IL) 222554

(51) Int. Cl. H04W 24/10

(52) U.S. Cl. CPC H04W 24/10; H04W 84/12

(57) ABSTRACT

There is provided a method for acquiring information regarding terrain and/or objects within a volume, said method comprising: transmitting signals over time (“node signals”) from one or more nodes of a wireless network (“subject network”); receiving the node signals after their traversing a medium (“node resultant signals”) using one or more receiving units (“node signal receivers”); measuring one or more physical attributes (“signal attributes”) for one or more of the node resultant signals, wherein at least one of the signal attributes is of at least one of the following types: (a) time difference between node signal transmission by the applicable transmitting subject network node and node resultant signal reception by the applicable node signal receiver; (b) phase difference between the transmitted node signal and the received node resultant signal; (c) power ratio between the transmitted node signal and the received node resultant signal; (d) frequency difference between the received node resultant signal and the transmitted node signal (Doppler shift); and/or (e) direction from which the node resultant signal has arrived, and/or its projection on one or more predefined axes; estimating the spatial location as a function of time for one or more of the transmitting subject network nodes and/or one or more of the node signal receivers; and analyzing one or more of the node resultant signals and/or one or more of the signal attributes to extract information regarding objects along the signal's paths (“mapping information”).

### CROSS-REFERENCE TO RELATED APPLICATIONS

This application claims the benefit of Israeli Patent Application 222554, filed Oct. 18, 2012, which is incorporated herein by reference.

### FIELD OF THE INVENTION

The present invention relates generally to employing wireless networks for acquiring information regarding terrain and/or objects within a volume.

### BACKGROUND OF THE INVENTION

### Wireless Networks and Their Uses

Wireless networks are used to transfer information between two or more spatial locations which are not physically linked. The information may be of any kind, e.g., voice, still or moving images, text and so forth. The information is typically transferred using radio frequency (RF) and/or infrared radiation.

Some of the common types of wireless networks, divided according to coverage area and network topology, are:

(a) Wireless personal area networks (WPANs), such as Bluetooth networks, which interconnect devices within a relatively small area;

(b) Wireless local area networks (WLANs), linking two or more devices over a relatively short distance, usually providing internet connection through an access point;

(c) Wireless mesh networks, whose nodes are organized in mesh topology, in which each node forwards messages on behalf of other nodes. Such networks automatically reroute around faulty nodes;

(d) Wireless metropolitan area networks (wireless MANs), e.g., WiMax, which may connect several WLANs;

(e) Wireless wide area networks (wireless WANs), which typically cover large areas, e.g., between neighboring towns;

(f) Cellular networks or mobile networks, distributed over areas called cells, each of which served by at least one fixed-location transceiver, known as a cell site or base station. Each cell typically uses a set of radio frequencies and/or codes which is different from that of the immediate neighboring cells, so as to reduce interference. When joined together, multiple cells may provide coverage over wide geographic areas, enabling a large number of portable transceivers, such as mobile phones (including smart phones) and pagers, to communicate with each other and with fixed transceivers and telephones anywhere in the network, via base stations. Although originally intended for telephone conversations, cellular networks also routinely carry other types of data, using technologies such as: global system for mobile communications (GSM), code division multiple access (CDMA), general packet radio service (GPRS), wideband code division multiple access (W-CDMA), enhanced data rates for GSM evolution (EDGE), CDMA2000, orthogonal frequency-division multiple access (OFDMA) and so forth; and

(g) Mobile satellite communications, based on telecommunication satellites. Typically used when other types of wireless connection are unavailable, e.g., in largely rural areas and remote locations, in aviation or in maritime platforms.

The location of mobile devices (e.g., cellular phones) connected to wireless networks is sometimes estimated using these networks. The estimation may be based on measurements made directly by the wireless network infrastructure and/or on external sources of information, e.g., global positioning system (GPS) trackers associated with the mobile devices. For example, US patent application US2012/109853, by Culpepper, Smith and Vancleave, published on May 3, 2012, titled “Method and system for providing tracking services to locate an asset,” discloses a method and system for asset location. Location data is received from a cellular transmitter associated with a selected asset, which location data includes data representative of a cellular receiver with which direct communication with the cellular transmitter is made. The location data is then communicated to a tracking service system, which tracking service system includes a database representative of geographic locations associated with the plurality of cellular receivers. The database is then queried with received location data so as to generate geographic tracking data associated with a location of a cellular receiver, the geographic tracking data including display data adapted to generate a map image including a representative of a location of the selected asset. The geographic tracking data is then communicated to an associated security agency so as to allow for viewing of an image generated in accordance with the display data and at least one of tracking and interception of the selected asset. In some embodiments, location data is also received from a GPS location system associated with the cellular transmitter. Another example is US patent application US2010/120449, by Jakorinne, Kuisma and Paananen, published on May 13, 2010, titled “Method and system for refining accuracy of location positioning,” which discloses a method and system for accurately determining the location of a mobile device. In the mapping phase, collected reference positioning data and collected cell data are used to map a covered area estimation, and in the actual location determination phase, the covered area estimation is calculated from actual environment data received through a wireless cellular communication network, and possibly but not necessarily from external databases. The covered area estimation comprises at least some of the following calculations: (i) estimation of base station location; (ii) estimation of transmission range; (iii) estimation of signal map; and (iv) estimation of area type. The actual location of the mobile device is determined from the covered area estimation based on relative comparison between the actual environment data and estimations (i)-(iv) and weight numbers resulted from the comparison. During both phases, a database is stored in the server and updated whenever new environment data is received. A further example is US patent application US2011/0059752, by Garin, Do and Zhang, published on Mar. 10, 2011, titled “Concurrent wireless transmitter mapping and mobile station positioning,” which discloses a method for concurrently estimating locations for one or more mobile stations and one or more mobile transmitters, said method comprising: receiving at a computing platform a plurality of range measurements from one or more mobile stations with unknown positions, the plurality of range measurements comprising one or more range measurements to one or more wireless transmitters with unknown positions and one or more range measurements to one or more wireless transmitters with known positions; and concurrently estimating locations for the one or more mobile stations with unknown positions and for the one or more wireless transmitters with unknown positions.

Wireless networks can also be used to estimate the location of multiple mobile devices as a function of time. Based on this information, one can create road maps, analyze traffic flow and provide dynamic route guidance for drivers. For example, US patent application US2010/211301, by McClellan, published on Aug. 19, 2010, titled “System and method for analyzing traffic flow,” discloses a system and method for analyzing traffic flow, comprising receiving location reports from a plurality of mobile devices, each of the location reports identifying a current location and current speed for a particular mobile device. For each of the location reports, the system identifies a current street from a street mapping database using the current location. The system stores the current speeds for the mobile devices so that each of the current speeds is associated with a street in the street mapping database. The current speeds may be stored in the street mapping database or in a separate database that is linked to the street mapping database. A further example is US patent application US2010/057336, by Levine, Shinar and Shabtai, published on Mar. 4, 2011, titled “System and method for road map creation,” which discloses a system and method for creation of a road map, the system comprising a plurality of navigation devices; and an application server to receive from the plurality of navigation devices time series of location points, and to create a road map based on the time series of location points. The method comprises receiving location points from a plurality of navigation devices, along with respective time stamps indicating the time of recordation of each of the location points; identifying at least one route according to the location points and respective time stamps; and creating a road map based on the at least one route. A further example is US patent application US2011/098915, by Disatnik, Shmuelevitz and Levine, published on Apr. 28, 2011, titled “Device, system, and method of dynamic route guidance,” which discloses a device, system and method of dynamic route guidance. For example, the method may include: calculating an optimal route from a first location, in which a navigation device is located, to a destination point entered by a user of said navigation device; receiving from the navigation device a travel update, indicating that the navigation device is located in a second location, wherein the second location is on said optimal route; and based on real-time traffic information and real-time road information, determining that an alternate route, from the second location to the destination point, is now an optimal route to the destination point.

Furthermore, mobile devices connected to wireless networks can be used to map network performance parameters as a function of space and/or time. For example, US patent application US2006/246887, by Barclay, Benco, Mahajan, McRoberts and Ruggerio, published on Nov. 2, 2006, titled “Mapping of weak RF signal areas in a wireless telecommunication system using customers' mobile units,” discloses a wireless mobile device, which includes an RF transmitter and receiver, where the receiver monitors signal strength of an RF signal from a base station. A control logic module compares the signal strength to a comparison level. The control logic module creates and stores a record in a memory module. The record includes a first signal strength level and parameters related to conditions existing at the time the comparing was done. The control logic module creates and stores the record if the level of said signal strength is less than the comparison level.

When fixed or mobile devices connected to a wireless network are associated with sensors capable of measuring one or more local physical parameters, the system can be used for detecting events in space and/or in time, e.g., for security purposes. For instance, US patent application US2008/169921, by Peeters, published on Jul. 17, 2008, titled “Method and apparatus for wide area surveillance of a terrorist or personal threat,” discloses methods and apparatuses for the wide area detection of major threats, including chemical, radiological or biological threats, using modified personal wireless devices, such as mobile phones, personal digital assistants (PDAs) or watches, combined with micro- and nano-sensor technologies. A “homeland security” chip is further provided, which combines the elements of geo-location, remote wireless communication and sensing into a single chip. The personal electronic devices can be further equipped for detecting various medically related threats. Similarly modified personal devices can be used to detect external threats that are person-specific. Another example is U.S. Pat. No. 7,952,476, by Causey, Andrus, Luu, Jones and Henry, issued on May 31, 2011, titled “Mobile security system,” which discloses a mobile security system, wherein a detector communicates with a mobile device if an event has occurred. The event may be of various types, such as fire or motion. Once the mobile device receives the communication of the event occurrence, the mobile device may, among others, sound an alarm or communicate with a central monitoring system to notify emergency services of the occurrence. The mobile device may also communicate with another communication device, such as another cell phone or a computer, using various forms of communication. The detector may be an integral part of the mobile device, and may also be wholly separate.

### Object Detection Using RF Sensors

Certain methods and systems known in the art employ sensors based on RF radiation for object detection outside the context of wireless networks.

In some systems, the object detection is based on active sensing. For instance, UK patent application GB2473743, by Bowring and Andrews, published on Mar. 23, 2011, titled “Detecting hidden objects,” discloses a system and method for detecting and identifying hidden objects, for instance for airport security screening. Low power plane-polarized microwave radiation is directed towards a person, and scattered radiation is detected by a detector sensitive to polarization in an orthogonal plane (cross-polarization). The transmitted and received planes of polarization are varied, either by rotation of both transmitting and receiving antennas on a common platform, synchronized rotation of both, or switching between antennas having fixed polarizations. The transmitted frequency is modulated over a broad range, using wide-band frequency modulation continuous wave (FMCW). The output signal of the receiver over a period of time is compared with expected returns in a neural network to identify the nature of any hidden object, and can distinguish a large knife, small knife, handgun and so on. An ultrasound sonar or stereoscopic camera may determine the distance to the person. Another example is PCT application WO2009/090406, by Mehta, published on Jul. 23, 2009, titled “Microwave imaging system,” which discloses a microwave imaging system for imaging a defined region, the system comprising a plurality of portable RF identification (RFID) tags, distributed around said region, for generating a plurality of RF signals and directing said signals to said defined region, and for receiving RF signals from said defined region; and means for transmitting the characteristics of said received signals to a remote processing station through a wireless communication channel, extracting image data from said received signals and constructing a corresponding image.

Other systems are based on passive sensing. For example, U.S. Pat. No. 8,179,310, by Westphal, issued on May 15, 2012, titled “Method for sensing a threat,” discloses a method for threat analysis based on the passive radar principle, using the transmitter in navigation satellites, a plurality of receiving stations, which are operated distributed over wide regions, and at least one evaluation center. The receiving stations act as wake-up sensors, transmit their received signals to at least one evaluation center for comparison with expected signals from each navigation satellite, and sense a threat. Depending on the result, stationary or mobile radar systems can then be used to obtain more precise details relating to a conspicuous entity, making it possible to decide on currently required protective or defensive measures. A further example is US patent application US2011/057828, by Brunet, published on Mar. 10, 2011, titled “Mapping method implementing a passive radar,” which discloses a mapping method implementing a radar used in passive mode. It is possible to use such a radar for locating an object likely to reflect an electromagnetic wave transmitted by a transmitter the position of which is known. Movable objects capable of reflecting rays received from transmitters of opportunity are used. The method comprises the following operations: determining, in a distance-Doppler matrix of the radar, points relative to the deviations between the rays received directly from the transmitters and the rays reflected by the movable object; transferring to a map to be established a probable zone of location of singularities of the electromagnetic field transmitted or reflected by the ground; and crossing several probable zones during the movement of the movable object in order to obtain the location of the singularities.

### Object Detection Using Wireless Network Infrastructure

Moreover, some methods and systems known in the art perform object detection using wireless network infrastructure. US patent application US2009/0040952, by Cover and Andersen, published on Feb. 12, 2009, titled “Systems and methods for microwave tomography,” discloses systems and methods for microwave tomography. According to various embodiments, signal strength values or other similar quality indications may be analyzed as they are received with packet data over a wireless network. The analysis may be used to determine the presence of a physical object substantially between communicating nodes in a wireless network. An output may be generated based on analyzed data. In addition, U.S. Pat. No. 6,745,038, by Callaway, Perkins, Shi and Patwari, issued on Jun. 1, 2004, title “Intra-piconet location determination and tomography,” discloses a technique for intra-piconet location determination and tomography. This technique uses received signal strength indicator (RSSI) values in conjunction with transmitted power levels to determine the relative location of each device within a small network employing frequency hopped spread spectrum transmission. In addition to capability of location determination, the geometry of the devices in the network, as well as the path loss information between pairs of devices, may be used to infer the location of absorbers and reflectors within the piconet. This absorption and reflection information may be used in creating the piconet tomography. The approach described in this specification may be applied in conjunction with the Bluetooth PAN specification to determine device locations, mitigate the effects of multi-path, and perform indoor location and security functions, and other application functions requiring cost-effective location determination.

### SUMMARY OF THE INVENTION

Embodiments of the present invention provide methods and devices for acquiring information regarding terrain and/or objects within a volume using wireless networks.

According to a first aspect of the invention, there is provided a method for acquiring information regarding terrain and/or objects within a volume, said method comprising:
transmitting signals over time (“node signals”) from one or more nodes of a wireless network (“subject network”);
receiving said node signals after their traversing a medium (“node resultant signals”) using one or more receiving units (“node signal receivers”);
measuring one or more physical attributes (“signal attributes”) for one or more of said node resultant signals, wherein at least one of said signal attributes is of at least one of the following types:

(a) Time difference between node signal transmission by the applicable transmitting subject network node and node resultant signal reception by the applicable node signal receiver;

(b) Phase difference between the transmitted node signal and the received node resultant signal;

(c) Power ratio between the transmitted node signal and the received node resultant signal;

(d) Frequency difference between the received node resultant signal and the transmitted node signal (Doppler shift); and/or

(e) Direction from which the node resultant signal has arrived, and/or its projection on one or more predefined axes; estimating the spatial location as a function of time for one or more of said transmitting subject network nodes and/or one or more of said node signal receivers; and

analyzing one or more of said node resultant signals and/or one or more of said signal attributes to extract information regarding objects along the signal's paths (“mapping information”).

Other aspects of the present invention are detailed in the claims.

### BRIEF DESCRIPTION OF THE DRAWINGS

The invention for employing wireless networks for acquiring information regarding terrain and/or objects within a volume is herein described, by way of example only, with reference to the accompanying drawings. With specific reference now to the drawings in detail, it is emphasized that the particulars shown are by way of example and for purposes of illustrative discussion of the embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

FIG. 1 is a schematic, pictorial illustration of a system for acquiring information regarding terrain and/or objects within a volume, in accordance with an embodiment of the present invention;

FIG. 2 is a schematic, pictorial illustration of a system for acquiring information regarding terrain and/or objects within a volume, in accordance with an embodiment of the present invention.

### DETAILED DESCRIPTION OF EMBODIMENTS

### System Description

In broad terms, the present invention relates to methods and systems for acquiring information regarding terrain and/or objects within a volume (“target volume”) using wireless networks.

Before explaining at least one embodiment of the invention in detail, it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

In embodiments of the present invention, a wireless network (“subject network”) includes at least two nodes, wherein one or more of the nodes of the subject network (“transmitting subject network nodes”) transmit signals over time (“node signals”). The node signals traverse a medium, such as the atmosphere or free space, undergoing various physical phenomena, such as attenuation, reflection from various objects, scattering by various objects, refraction by various objects, diffraction, dispersion, multi-path, and so forth (the resulting signals are referred to as the “node resultant signals”), and are received by one or more receiving units (“node signal receivers”). The node resultant signals, received by the node signal receivers, are analyzed by one or more processing units (“mapping units”).

In certain embodiments, all the transmitting subject network nodes and all the node signal receivers are stationary. In other embodiments, at least one of the transmitting subject network nodes and/or at least one of the node signal receivers are mobile.

The subject network may be of any type known in the art, e.g., WPAN, WLAN, wireless mesh network, wireless MAN, wireless WAN, cellular network, mobile satellite communications network, radio network and/or television network. The transmitting subject network nodes may be of any kind known in the art, e.g., base stations and/or mobile phones in a cellular network.

If two or more of the transmitting subject network nodes transmit concurrently, the node resultant signals corresponding to the different node signals may be differentiated based on any method known in the art. For instance, each of the transmitting subject network nodes may employ a different frequency band, a different code type (e.g., linear frequency modulation, phase shift keying, frequency shift keying and so forth), a different set of code parameters, and/or a different polarization scheme (e.g., horizontal or vertical linear polarization, right-hand or left-hand circular polarization and so on), so that the resulting signal waveforms would be essentially orthogonal. Additionally or alternatively, multiple access methods may be employed, e.g., time division multiple access (TDMA), frequency division multiple access (FDMA) or code division multiple access (CDMA). In some embodiments, the transmitting subject network nodes may employ the same waveform, but be sufficiently separated spatially (e.g., the transmitting subject network nodes may be distant from each other and/or transmit at separated spatial angles) to support reasonable differentiation and acceptable levels of mutual interference.

In embodiments, each node signal receiver may be one of:

(a) Associated with a node of the subject network, which may be one of the transmitting subject network nodes or one of the other nodes; or

(b) A sensor configured to measure the node signals and/or the node resultant signals. The sensor may be one of:
(i) Passive, only capable of receiving signals transmitted by other elements; or
(ii) Active, capable of both transmitting and receiving signals.

In some embodiments, all node signals are produces as a part of the normal operation of the wireless network. In other embodiments, some or all of the node signals are especially produced for acquiring information regarding the target volume; for example, one or more nodes may transmit signals at time varying directions, scanning the target volume over time, and employing radar-like processing.

In further embodiments, the analysis of the node resultant signals may be performed analogically, digitally, or using a combination thereof.

In certain embodiments, one or more mapping units are associated with at least one of the node signal receivers (“local mapping units”). In some embodiments, one or more central mapping units analyze the outputs of the local mapping units and/or the node resultant signals. In other embodiments, all node resultant signals are processed by one or more central mapping units.

In some embodiments, the central processing unit may be completely separated from the local mapping units. In other embodiments, one or more of the local mapping units may also serve the function of central mapping units. In further embodiments, the functions of the central mapping units may be divided between several local mapping units.

In further embodiments, the spatial location as a function of time for one or more of the transmitting subject network nodes and/or one or more of the node signal receivers is either measured directly or can be estimated. Location measurements can be made by means of any navigation system known in the art, e.g., using GPS and/or inertial navigation, wherein the resulting location information may or may not be filtered over time to enhance results. Additionally or alternatively, location estimation may be made employing any method known in the art, e.g., the methods of patent applications US2012/109853, US2010/120449 and/or US2011/0059752, referenced herein above.

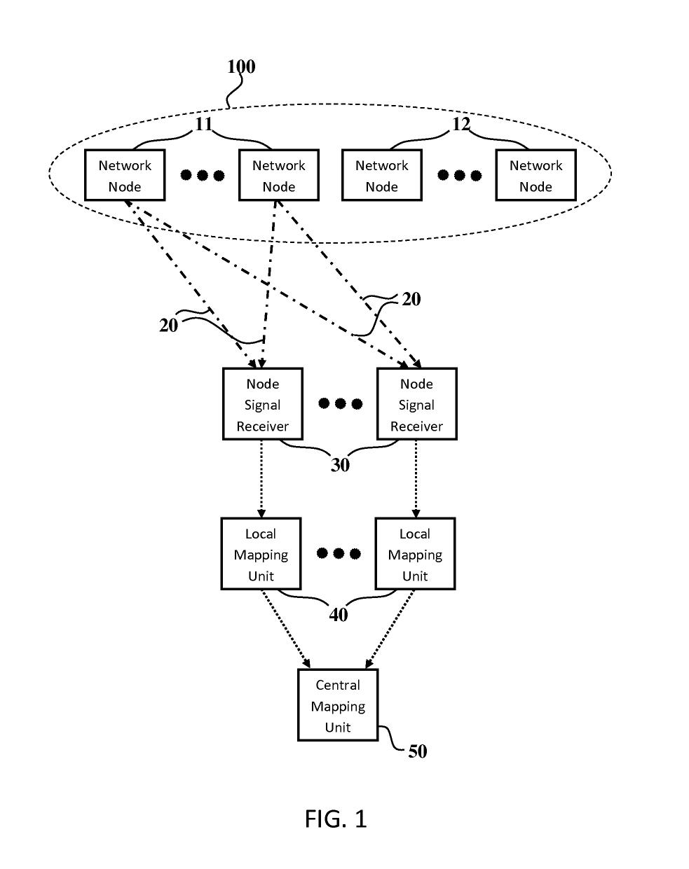

An exemplary system configuration, wherein all node signal receivers are not directly associated with nodes of the subject network, and are sensors configured to measure the node signals and/or the node resultant signals, can be seen in FIG. 1. The subject network 100 comprises transmitting subject network nodes 11 and non-transmitting subject network nodes 12. The node signals 20 traverse the medium, and the node resultant signals are received by the node signal receivers 30. These signals are then processed by the local mapping units 40 and/or central mapping unit 50. In the figure, wireless transmissions are marked by dash-dotted lines, and data lines, which may be wired or wireless, are marked by dotted lines.

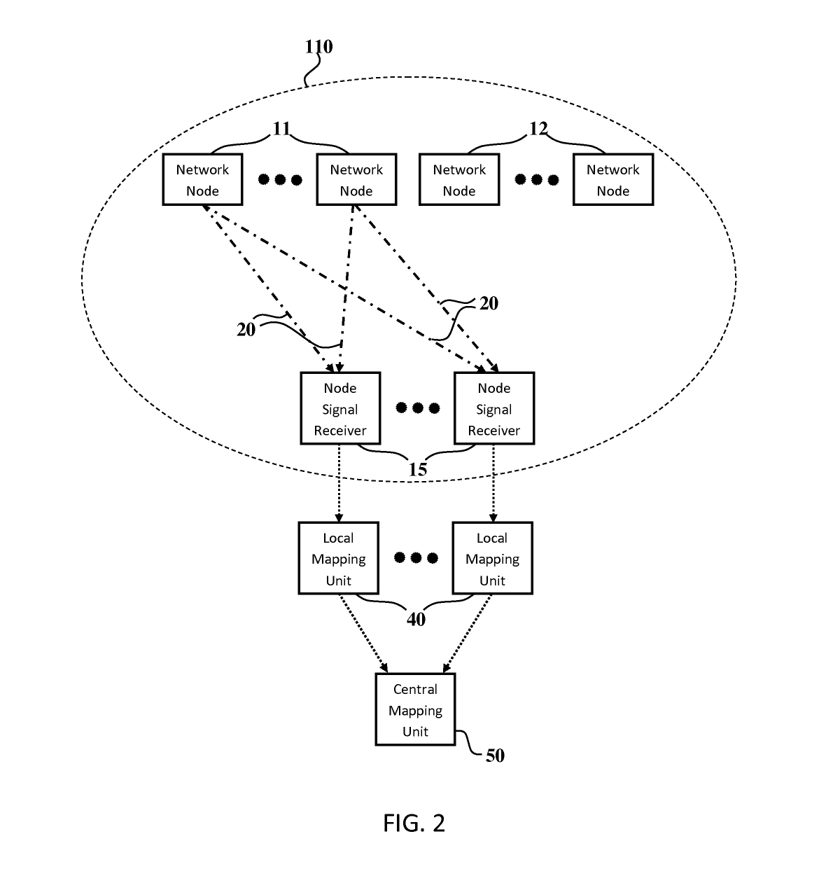

Another exemplary system configuration, wherein all node signal receivers are associated with nodes of the subject network, can be seen in FIG. 2. The subject network 110 comprises transmitting subject network nodes 11, non-transmitting subject network nodes 12, and node signal receivers 15. The node signals 20 traverse the medium, and the node resultant signals are received by the node signal receivers 15. These signals are then processed by the local mapping units 40 and/or central mapping unit 50. In the figure, wireless transmissions are marked by dash-dotted lines, and data lines, which may be wired or wireless, are marked by dotted lines.

### Physical Parameter Measurements

In embodiments, for at least one of the node signal receivers, for the node resultant signals associated with at least one of the transmitting subject network nodes, one or more of the following physical parameters (“signal attributes”) is measured per node signal receiver and per transmitting subject network node, wherein the measurements may be made either for the entire node resultant signal or for certain time swaths thereof:

(a) Time difference, Δt, between node signal transmission by the applicable transmitting subject network node and node resultant signal reception by the applicable node signal receiver. This time difference is proportional to the distance, R, traversed by the node signal along its path through the medium:

Δt=R/c (1)

where c is the speed of the signal's propagation within the medium, e.g., the speed of light;

(b) Phase difference, Δφ, between the transmitted node signal and the received node resultant signal. For example, if the node signal is known, the phase difference may be measured by applying a matched filter between the node signal and the node resultant signal. Alternatively, if the node signal is generally unknown, but certain sections of the node signal are predefined for the current communication protocol, the matched filter may be applied for one or more of these sections. Such techniques may necessitate phase synchronization between one or more of the transmitting subject network nodes and one or more of the node signal receivers.

The measured phase difference may be used to enhance the estimation of the distance traversed by the signal along its path through the medium, based on the following equation:

$$Δϕ = mod ( \frac{2 π}{λ} R , 2 π ) \qquad ( 2 )$$

where mod is the modulus operator and λ is the wavelength of the transmitted signal;

(c) Power ratio, Rₚ, between the transmitted node signal and the received node resultant signal. For example, one may employ the received signal strength indication (RSSI), measuring the power of a signal received in a wireless communication node. This power ratio is affected by the distance traversed by the node signal along its path through the medium (the local signal power is inversely proportional to the squared distance from the transmitting subject network node, and to the medium losses, which increase with distance), as well as by physical attributes of objects along the path of the node signal (e.g., reflection coefficients of surfaces from which the signal has been reflected, and/or attenuation coefficients of objects along the path of the signal);

(d) Frequency difference, f_{D}, between the received node resultant signal and the transmitted node signal, i.e., the signal's Doppler shift. The frequency of the received node resultant signal may be measured by any method known in the art. For example, in cases where a transmitted node signal comprises multiple pulses, and a node signal receiver employs digital processing, one may apply Fourier analysis to one or more time gates of a received node resultant signal. Time gates of the received signal are defined as time intervals of a certain duration, wherein time is measured with respect to the rise-time of the last transmitted pulse, so that the number of samples for each time gate equals the number of pulses for which measurements have been made. According to the Doppler effect, in cases where the node signal interacts with M objects along its path, the Doppler shift equals:

$${f}_{D} = \frac{1}{λ} {Σ}_{i = 0}^{M + 1} [ \frac{d }{d t} ( {R}_{i , i + 1} ) ] \qquad ( 3 )$$

wherein d/dt is the time derivative operator, and R_{n,m} is the distance between the n'th and the m'th object along the signal's path, wherein the 0'th object is the applicable transmitting subject network node, the (M+1)'th object is the applicable node signal receiver, and the remaining objects are ordered according signal's interaction sequence with them. In the specific case where the signal does not interact with any moving elements along its path, the Doppler shift equals:

$${f}_{D} = - \frac{1}{λ} ( \vec{{V}_{N}} \cdot - \vec{{V}_{R}} \cdot ) \qquad ( 4 )$$

wherein (·) is the dot-product operator, \vec{V_{N}} is velocity vector of the applicable transmitting subject network node, \vec{V_{R}} is the velocity vector of the applicable node signal receiver, [symbol] is the unit vector of the signal's path through the medium just outside the applicable transmitting subject network node, and [symbol] is the unit vector of the signal's path through the medium just outside the applicable node signal receiver, wherein all vectors are defined with respect to the same predefined coordinate system (“reference coordinate system”);

(e) Direction from which the node resultant signal has arrived (“node resultant signal direction”), i.e., the unit vector of the node resultant signal's path through the medium just outside the applicable node signal receiver, and/or its projection on one or more predefined axes. This direction and/or its projections may be measured using any method known in the art. For example, when an applicable node signal receiver supports two or more concurrent receive beam configurations, one may employ monopulse techniques, which are commonly used in radar systems. Additionally or alternatively, when an applicable node signal receiver supports two or more different receive beam configurations, each of which employed at a different time, one may make use of a predefined scanning pattern, e.g., conical scan, which is ubiquitous in radar systems. The two or more receive beam configurations may differ from each other in at least one of the following parameters:
(i) Direction of maximal antenna gain on receive (“boresight”);
(ii) Pattern of antenna gain on receive as a function of spatial angle with respect to the boresight (“antenna pattern”);
(iii) Phase center; and/or
(iv) Polarization.
   Additionally or alternatively, interferometric methods and/or multilateration methods may be employed. Note that, in cases where the node signal interacts with one or more objects along its path, the direction from which the node resultant signal arrives relates to the section of the path from the last object with which the node signal interacts to the node signal receiver; and/or

(f) When there are multiple signal paths from a transmitting subject network node to a node signal receiver, i.e., in the presence of multi-path, the received node resultant signal is the coherent sum of the signals resulting from the different signal paths, each of which is referred to as a “node resultant signal component”. In such cases, one or more of signal attributes (a)-(e) may be measured for one or more node resultant signal components. For that purpose, one may employ any method known in the art for separating the different received signal components, or for extracting the signal attributes directly from multiple received signal components. For example, one or more of the following methods may be used:
(i) One may apply an autocorrelation function to the received node resultant signal, and detect discernible peaks in the output (“autocorrelation peaks”). The criteria for a peak to be discernible may include, for example: the peak height provides a signal-to-noise ratio which exceeds a certain threshold; the ratio between the peak height and the maximal peak height exceeds a certain threshold; the peak width is lower than a certain threshold; the ratio between the peak height and the peak width exceeds a certain threshold; and so forth. Multiple autocorrelation peaks may be indicative of multiple node resultant signal components. One may employ the autocorrelation peaks to extract information regarding relative and/or absolute values of signal attributes of one or more node resultant signal components. For example, the value of Δt for the n'th resultant signal component equals the value of Δt for the earliest node resultant signal component plus the time difference between the first (leftmost) autocorrelation peak and the n'th autocorrelation peak;
(ii) If the node signal or parts thereof are known, one may apply cross-correlation between the received node resultant signal and the node signal. The output may be processed in a way similar to that of the autocorrelation output of method (i) above;
(iii) One may apply a matched filter to the received node resultant signal, configured to detect certain sections of the node signal which are expected to appear in specific parts of the signal, based on the current communication protocol. Such specific parts of the signal may include, for example, control information for data packets, which typically is part of the packets' header and/or trailer. The output may be processed in a way similar to that of the autocorrelation output of method (i) herein above;
(iv) One may employ the output of the autocorrelation function of method (i), the cross-correlation function of method (ii) and/or the matched filter of method (iii) herein (collectively the “correlation function output”) to estimate the earliest or the strongest node resultant signal component (the “main node resultant signal component”). This may be performed, for example, by applying de-convolution between the received node resultant signal and the correlation function output. Additionally or alternatively, one may employ a regular decoding scheme, which may include error correction, and then reconstruct the main node resultant signal component. Once this component has been constructed, one may subtract it from the node resultant signal, to obtain the coherent sum of the remaining node resultant signal components. This process may be iteratively repeated several times, to separately extract the different node resultant signal components. One or more of signal attributes (a)-(e) may then be computed for each node resultant signal component; and/or
(v) In cases where the different node resultant signal components do not overlap in time, one may simply separate them based on time of reception. One or more of signal attributes (a)-(e) may then be computed for each node resultant signal component.

In some embodiments, the signal attribute measurement may also involve comparing two or more node resultant signals so as to extract one or more physical attributes, each of which may be relative of absolute; wherein the term “relative physical attributes” in this context refers to the ratio and/or difference between the values of such physical attributes, associated with two or more node resultant signals. For example, one may apply cross-correlation between two or more node resultant signals or certain time swaths thereof, and detect discernible peaks in the output (“cross-correlation peaks”). The cross-correlation peaks may then be used, for instance, for estimating the difference in time duration (“relative time duration”) from node signal transmission by the applicable transmitting subject network node to node resultant signal reception by the applicable node signal receiver, associated with two or more node resultant signals. When producing mapping information, the time duration measurements may be used, for instance, for multilateration.

The signal attribute measurement may be performed analogically, digitally, or using a combination thereof.

In some embodiments, the signal attribute measurement may be performed by the node signal receivers. This may also be done by one or more local mapping units associated with the applicable node signal receivers. Additionally or alternatively, analog or digital data from one or more node signal receivers may be transferred to one or more central mapping units, configured to perform the signal attribute measurements in part or in whole. The central mapping unit may then apply additional processing to these measurements. In further embodiments, signal attribute measurements made by one or more local mapping units may be transferred to a central mapping unit, which may apply additional processing to these measurements.

In further embodiments, information regarding the current spatial location and/or previous spatial locations as a function of time (“location history”) for one or more of the transmitting subject network nodes and/or one or more of the node signal receivers is transferred to one or more of the mapping units (local mapping units and/or central mapping units). The current locations and/or location history may be employed by the mapping units to estimate the values for one or more of the signal attributes for direct paths between the transmitting subject network nodes and the node signal receivers (“nominal signal attribute values”), without any objects along the node signals' path except for the nominal medium, wherein the nominal medium may be, e.g., the atmosphere or free space.

In even further embodiments, the mapping units may compound the nominal signal attribute values with the measured signal attribute values, to provide information regarding physical phenomena within the medium (“medium attributes”). For instance, one may compute for at least one of the node signal receivers and at least one of the transmitting subject network nodes, for either the applicable node resultant signals or for one or more node resultant signal components, for either the entire node resultant signal or for certain time swaths thereof:

(a) The difference between the distance R traversed by the node signal along its path through the medium (“measured distance”) and the direct distance D between the applicable transmitting subject network node and the applicable node signal receiver (“physical distance”). This distance difference (“path delay distance”) equals the path delay times the speed of signal's propagation within the medium. The measured distance may be based on the time difference signal attribute and/or on the phase difference signal attribute. The physical distance may be computed either as the geometric distance or as the optic distance within the medium, taking into account refraction effects within the medium that do not result from objects along the node signal's path (e.g., atmospheric refraction, caused by spatial variations in the local atmospheric temperature, pressure and humidity levels);

(b) The measured power ratio signal attribute, divided by the power ratio between the transmitted node signal and the expected node resultant signal. The result (“path attenuation factor”) is the attenuation factor resulting from objects along the node signal path, which may be caused by actual attenuation, reflections with reflection coefficients lower than 1.0, scattering and the like. The expected node resultant signal may be computed based on the transmitted signal power and the expected reduction in power as a function of distance traversed through the medium, using either the measured distance or the physical distance;

(c) The measured power ratio signal attribute, divided by the power ratio between the transmitted node signal and the node resultant signal expected based on the assumption that the node signal traverses along a straight line or along an optic path, taking into account refraction effects within the medium that do not result from objects along the node signal's path. The result (“path delay attenuation factor”) may be used to estimate the distance R traversed by the node signal along its path through the medium, in cases where the time difference signal attribute is not computed. The distance R may be approximately derived from the path delay attenuation factor by imposing a certain assumption. For example, if we attribute the entire path delay attenuation factor to losses within the medium due to path delay, we can estimate the difference between R and D. This assumption may be appropriate, e.g., for the earliest node resultant signal component; and/or

(d) The measured frequency difference signal attribute, minus the expected Doppler shift; wherein the expected Doppler shift is based on the relative spatial location and velocity vectors of the applicable transmitting subject network node and the applicable node signal receiver. As demonstrated in eq. 3 and eq. 4, the result (“path Doppler shift”) is affected by the following:
(i) The difference in spatial angle between the unit vector of the signal's path through the medium just outside the applicable transmitting subject network node, and the unit vector connecting the applicable transmitting subject network node and the applicable node signal receiver (either using a straight line or using a curve which takes into account refraction effects within the medium that do not result from objects along the node signal's path);
(ii) The difference in spatial angle between the unit vector of the signal's path through the medium just outside the applicable node signal receiver, and the unit vector connecting the applicable node signal receiver and the applicable transmitting subject network node (either using a straight line or using a curve which takes into account refraction effects within the medium that do not result from objects along the node signal's path); and
(iii) The motion velocity of each object along the node signal's path and the unit vector of the signal's path just before and just after the interaction with the corresponding objects along the node signal's path.
   If one or more of the parameters affecting the path Doppler shift is known or can be estimated, one can extract information regarding some or all of the remaining affecting parameters. For example, the node resultant signal direction attribute provides information regarding affecting parameter (ii).
   Terrain and/or Volume Mapping

In embodiments, the mapping units may analyze one or more node resultant signals and/or signal attributes and/or medium attributes for one or more transmitting subject network nodes and one or more node signal receivers, either at a specific time swath or as a function of time, to extract information regarding objects along the signal's paths (“mapping information”). For example, the mapping information may include at least one of: digital terrain models (DTM), digital surface models (DSM), as well as detection, localization, characterization, classification and/or tracking data of objects within volumes and/or over terrains, said information may or may not be time dependent and/or space dependent. The term “objects” here relates to static and/or dynamic objects, each of which may be inanimate or animate, e.g., animals, human beings, various vehicles, buildings and so forth.

In some embodiments, the mapping information may be produced using at least one of the following methods:

(a) Analyzing one or more node resultant signals and/or signal attributes and/or medium attributes over time and applying a change detection method. Any change detection method known in the art may be employed. For example, if the applicable transmitting subject network node and node signal receiver are immobile, significant changes in the signal attributes and/or the medium attributes are indicative of new objects, changed objects and/or objects whose location has changed within the volume. The measured changes in the signal attributes and/or the medium attributes may be employed for localization, characterization and/or classification purposes;

(b) Applying a forward problem method, using a-priori information and/or certain assumptions regarding the terrain and/or volume. The a-priori information may include:
(i) Information previously produced by systems or methods of the present invention;
(ii) Measurements made by the subject network and/or additional hardware in the subject network's site; and/or
(iii) External information, such as DTM and/or DSM databases.
   Any forward problem method known in the art may be employed, e.g., ray tracing and/or any wave propagation model appropriate for the frequency band, the network configuration (e.g., area-to-area versus point-to-point) and the medium configuration (e.g., models for indoor versus outdoor applications);

(c) Applying a forward problem method, using a-priori information and/or certain assumptions regarding the terrain and/or volume, as in method (b) above, and comparing the measured node resultant signals and/or the signal attributes and/or the medium attributes to computed values;

(d) Iteratively applying a forward problem method, wherein in each step a hypothesized terrain and/or volume map is defined, and the outputs of the forward problem method, when compared to one or more measured node resultant signals and/or signal attributes and/or medium attributes, are used to adjust the hypothesized terrain and/or volume map. Note that such an iterative method may be continuously applied to the measurements as a function of time, to inherently provide time dependent mapping information; and/or

(e) Applying an inverse problem method to one or more measurable physical parameters, such as the local attenuation coefficient and/or the local reflection coefficient and/or spatial location, each of which may or may not be time dependent. Any inverse problem method known in the art may be employed, e.g., Hough transform based algorithms, such as computed tomography, microwave tomography and/or diffraction tomography.

(f) Compounding one or more node resultant signals, so as to extract information regarding objects along the signals' paths. This may be performed, for example, using interferometry. Additionally or alternatively, one may employ multilateration techniques for certain objects, e.g., based on relative time duration measurements. Another example is treating two or more node signal receivers as elements of a receiving array, and applying any beamforming technique known in the art to the node resultant signals.

In further embodiments, wherein at least one of the transmitting subject network nodes and/or at least one of the node signal receivers moves over time (e.g., a mobile phone in a cellular network, moving with the person carrying it), node resultant signals and/or signal attributes and/or medium attributes, measured at multiple spatial configurations of the transmitting subject network nodes and/or the node signal receivers, are employed for producing mapping information.

In even further embodiments, wherein at least one of the objects within the target volume moves over time, node resultant signals and/or signal attributes and/or medium attributes, measured when the at least one of the objects within the target volume is in different locations, are employed for producing mapping information.

An exemplary inverse problem method for producing the mapping information (“multi-path reconstruction method”):

(a) This method assumes that the earliest node resultant signal component, which is still affected by multi-path (i.e., excluding the component associated with the direct path from the applicable transmitting subject network node to the applicable node signal receiver), referred to herein as the “first multi-path signal component”, is the result of a exactly a single reflection along the signal path (“single reflection assumption”). For the first multi-path signal component of a specific node resultant signal, the possible spatial locations of the reflecting surface producing the first multi-path signal component (“component reflecting surface”) may be defined using at least one of the following criteria:
(i) The component reflecting surface is located over an ellipsoid surface, whose foci correspond to the locations of the applicable transmitting subject network node and the applicable node signal receiver, wherein the ellipsoid is the figure formed from all points whose sum of distances from the two foci equals the measured distance for the first multi-path signal component;
(ii) The node resultant signal direction for the first multi-path signal component corresponds to the spatial angle between the component reflecting surface and the node signal receiver; and/or
(iii) In the presence of a non-zero Doppler shift, and assuming that the component reflecting surface is approximately immobile, the path Doppler shift defines a group of allowable spatial angles between the component reflecting surface and the node signal receiver.
   The method employs first multi-path signal components corresponding to multiple node resultant signals, and registers the possible spatial locations of reflecting surfaces for each of the first multi-path signal components over a three-dimensional space, in a manner similar to that of the Hough transform. Actual reflective surfaces are located where registrations from a relatively high number of first multi-path signal components are present. Note that this technique compounds information from a large number of node resultant signals, so that outliers being a consequence of the inaccuracy of the single reflection assumption are inherently rejected;

(b) Once the first multi-path signal components for two or more of the node resultant signals have been addressed, additional signal components may be analyzed in a similar fashion, using one or more hypotheses regarding the path traversed by each signal component, for example:
(i) The signal component results from exactly a single reflection along the signal path; and/or
(ii) The signal component results from exactly two signal reflections along the signal's path, one of which has already been found in a previous step;

(c) After generating a map of the spatial location of reflective surfaces, their reflection coefficient and/or the attenuation along paths between them may be estimated. For example, for each first multi-path signal component, one may assign to the corresponding reflective surface a reflection coefficient corresponding to the path delay attenuation factor. For reflective surfaces affecting the first multi-path signal component of more than one node resultant signal, one may assume that the maximal estimation of the reflection coefficient over all node signals is correct, and assign the remaining power loss to attenuation along the signal's path.

### Object Classification

In some embodiments, the mapping units may classify objects within the target volume. Any classification and/or target filtering method known in the art may be employed for these purposes. For instance:

(a) One may compute object characteristics and compare them to predefined reference models. Object characteristics may include, for instance, estimated object dimensions, motion velocity, reflection coefficient, attenuation coefficient and so forth. The comparison to reference models may be based on any technique known in the art, for example:
(i) Applying one or more thresholds to each object characteristic, to obtain a set of binary values. Predefined logic criteria may then be applied to the set of binary values, e.g., the sum of the binary values should exceed a certain number;
(ii) Applying one or more thresholds to each object characteristic, to obtain a set of binary values, and then using the Dempster-Shafer theory;
(iii) Defining a multi-dimensional characteristic space, whose dimensionality matches the number of object characteristics, and mapping object types to sub-spaces; and/or
(iv) Employing neural-network algorithms.

(b) The presence of a subject network node in immediate proximity to the object may be used as a source of information. For instance, cellular phones are typically carried by humans but not by animals; and/or

(c) Volumes wherein certain object types are not expected to be found may be defined, thus reducing false alarms.

In further embodiments, the mapping units may detect and handle only objects of specific types (“relevant objects”), e.g., humans, and not respond to other types of objects. The above described classification methods may be used for these purposes as well.

In even further embodiments, the mapping units may have to cope with electronic counter measures (ECM). Any method known in the art may be applied to detect and cope with ECM. Some exemplary techniques for detecting ECM:

(a) Noise jammers, e.g., spot, sweep or barrage jammers, may be detected based on their signal pattern as a function of space and/or time; and/or

(b) Phantom objects, produced by deceptive jammers, may be discerned from true objects based on self consistency checks of the signal attributes associated with such objects. For example, mismatch between the time derivative of the measured distance from one or more of the node signal receivers and the measured Doppler shifts for these node signal receivers may be indicative of phantom objects.

Some exemplary techniques for coping with ECM:

(a) The waveform of noise jammers may be estimated, and the subject network's waveforms may be adjusted so as not to be affected by the noise jammers; and/or

(b) Detected objects which are determined to be phantom objects may be discarded.

### Exemplary Applications

The systems and methods of the present invention may be used for a wide variety of applications. Some exemplary applications:

(a) Security systems, which may detect, localize, characterize, classify and/or track objects within volumes and/or over terrains. The security systems may also detect and/or classify carried objects, such as concealed weapons, explosives and/or drugs. The coverage volumes of these security systems may match the type of subject network or networks used. For example, WPANs may be employed for personal security systems; WLANs for home security systems or for security systems for large buildings or facilities, such as shopping centers, airport terminals, oil rigs and the like; and cellular networks for securing large areas, e.g., borders, defense zones surrounding certain facilities or agricultural areas, as well as large buildings, such as shopping centers, airport terminals and so forth;

(b) Estimation of the location of people and/or vehicles as a function of time, e.g., for traffic analysis, wherein the people and/or vehicles do not necessarily carry a transmitting subject network node such as a mobile phone. Various network types may be employed, including, e.g., WLANs and/or cellular networks;

(c) Obstacle detection for moving vehicles, e.g., airplanes, trains, trucks, busses and cars. The subject network may be installed on the moving vehicle itself, and/or on other platforms, each of which may be mobile or immobile; and

(d) Terrain and/or volume mapping systems, e.g., for cartography. Such systems are typically designed to acquire information regarding immobile objects, whereas mobile elements are discarded.

One of the advantages of the systems and methods of the current invention is that the information regarding the terrain and/or the objects within the volume may be acquired using wireless networks, which are very common nowadays. One may use existing networks, and/or add new ones. In some embodiments, only software changes to a wireless network system may be required. In other embodiments, only hardware changes are required, or a combination of hardware and software changes. For instance, one or more base stations for cellular or WLAN networks may be added in order to enhance the system's performance, e.g., for improving the object location accuracy. As a byproduct, the performance of the wireless network as a communication system may improve as well.

The fact that wireless networks are used:

(a) Contributes to the systems' cost-effectiveness. Already existing production lines may be adapted to accommodate the present invention, and previously installed wireless networks may be retrofitted to support the new features; and

(b) Limits the additional radiation within the atmosphere, which results from employing the systems and methods, thus reducing people's exposure to unnecessary radiation.

Integration with Additional Systems

In certain embodiments, the systems of the present invention may be integrated with additional sensors, providing supplementary information to the mapping units. For example, in security applications, the additional sensors may include sensors traditionally employed in security and surveillance systems, such as motion sensors, photo-electric beams, shock detectors, glass break detectors, still and/or video cameras, which may be optic and/or electro-optic, other electro-optic sensors, radars and/or sonar systems.

In further embodiments, the systems of the present invention may be integrated with other systems, to provide combined functionality. For example, in obstacle detection applications, a system of the present invention may be integrated with another type of obstacle detection system, e.g., based on image processing of information acquired by one of more video cameras.

1. A method for acquiring information regarding terrain and/or objects within a volume, said method comprising:
transmitting signals over time (“node signals”) from one or more nodes of a wireless network (“subject network”);
receiving the node signals after their traversing a medium (“node resultant signals”) using one or more receiving units (“node signal receivers”);
measuring one or more physical attributes (“signal attributes”) for one or more of the node resultant signals, wherein at least one of the signal attributes is of at least one of the following types:
(a) Time difference between node signal transmission by the applicable transmitting subject network node and node resultant signal reception by the applicable node signal receiver;
(b) Phase difference between the transmitted node signal and the received node resultant signal;
(c) Power ratio between the transmitted node signal and the received node resultant signal;
(d) Frequency difference between the received node resultant signal and the transmitted node signal (Doppler shift); and/or
(e) Direction from which the node resultant signal has arrived, and/or its projection on one or more predefined axes;
estimating the spatial location as a function of time for one or more of the transmitting subject network nodes and/or one or more of the node signal receivers; and
analyzing one or more of the node resultant signals and/or one or more of the signal attributes to extract information regarding objects along the signal's paths (“mapping information”).

2. (canceled)

3. (canceled)

4. The method of claim 1, wherein the subject network is of at least one of the following types:
(a) Wireless personal area network (WPAN);
(b) Wireless local area network (WLAN);
(c) Wireless mesh network;
(d) Wireless metropolitan area network (wireless MAN);
(e) Wireless wide area network (wireless WAN);
(f) Cellular network or mobile network;
(g) Satellite communications network;
(h) Mobile satellite communications network;
(i) Radio network; and/or
(j) Television network.

5. (canceled)

6. (canceled)

7. (canceled)

8. The method of claim 1, wherein each node signal receiver is one of:
(a) Associated with a node of the subject network, which may be one of the transmitting subject network nodes or one of the other nodes; or
(b) A sensor configured to measure the node signals and/or the node resultant signals, wherein the sensor may be: (i) passive, only capable of receiving signals transmitted by other elements; or (ii) active, capable of both transmitting and receiving signals.

9. (canceled)

10. (canceled)

11. The method of claim 1, wherein the estimation of the spatial location as a function of time is based on at least one of:
(a) Location measurements using a navigation system; and/or
(b) Location estimation using node signals and/or node resultant signals.

12. The method of claim 1, wherein the direction from which the node resultant signal has arrived is measured using at least one of the following methods:
(a) Monopulse;
(b) Predefined scanning pattern, such as conical scan;
(c) Interferometry; and/or
(d) Multilateration.

13. The method of claim 1, wherein one or more of the node resultant signals is affected by multi-path, and is therefore the coherent sum of signals resulting from multiple signal paths (“node resultant signal components”), and wherein the analysis of the one or more of the node resultant signals and/or one or more of the signal attributes further comprises at least one of:
(a) Separating the node resultant signal components; and/or
(b) Extracting signal attributes directly from multiple node resultant signal components.

14. The method of claim 13, wherein one or more of the following methods is used:
(a) Apply an autocorrelation function to the received node resultant signal, and detect discernible peaks in the output (“autocorrelation peaks”). The autocorrelation peaks are then used to extract information regarding relative and/or absolute values of signal attributes of one or more node resultant signal components;
(b) Apply cross-correlation between the received node resultant signal and the node signal or parts thereof which are known. The peaks in the output are then used to extract information regarding relative and/or absolute values of signal attributes of one or more node resultant signal components;
(c) Apply a matched filter to the received node resultant signal, configured to detect certain sections of the node signal which are expected to appear in specific parts of the signal, based on the subject network's communication protocol. The output is then used to extract information regarding relative and/or absolute values of signal attributes of one or more node resultant signal components;
(d) Iteratively analyze the node resultant signal, wherein in each step one of the node resultant signal components is estimated, and then subtracted from the node resultant signal, to obtain the coherent sum of the remaining node resultant signal components; and/or
(e) Separate the node resultant signal components based on time of reception.

15. (canceled)

16. The method of claim 1, wherein the analysis of the one or more of the node resultant signals and/or one or more of the signal attributes further comprises one or more the following:
(a) Employing information regarding the current spatial location and/or previous spatial locations as a function of time (“location history”) for one or more of the transmitting subject network nodes and/or one or more of the node signal receivers, in order to estimate the values for one or more of the signal attributes for direct paths between the transmitting subject network nodes and the node signal receivers (“nominal signal attribute values”), without any objects along the node signals' path except for the nominal medium; and/or
(b) Compounding the nominal signal attribute values with the measured signal attribute values, to provide information regarding physical phenomena within the medium (“medium attributes”).

17. (canceled)

18. The method of claim 16, wherein at least one of the medium attributes is at least one of:
(a) The difference (“path delay distance”) between the distance traversed by the node signal along its path through the medium (“measured distance”) and the direct distance between the applicable transmitting subject network node and the applicable node signal receiver (“physical distance”); wherein the measured distance may be based on the time difference signal attribute and/or on the phase difference signal attribute; and wherein the physical distance may be computed either as the geometric distance or as the optic distance within the medium, taking into account refraction effects within the medium that do not result from objects along the node signal's path;
(b) The measured power ratio signal attribute, divided by the power ratio between the transmitted node signal and the expected node resultant signal; wherein the expected node resultant signal may be computed based on the transmitted signal power and the expected reduction in power as a function of distance traversed through the medium, using either the measured distance or the physical distance;
(c) The measured power ratio signal attribute, divided by the power ratio between the transmitted node signal and the node resultant signal expected based on the assumption that the node signal traverses along a straight line or along an optic path, taking into account refraction effects within the medium that do not result from objects along the node signal's path; and/or
(d) The measured frequency difference signal attribute, minus the expected Doppler shift; wherein the expected Doppler shift is based on the relative spatial location and velocity vectors of the applicable transmitting subject network node and the applicable node signal receiver.

19. The method of claim 1, wherein the mapping information includes at least one of the following:
(a) Digital terrain models (DTM);
(b) Digital surface models (DSM);
(c) Detection data of objects within volumes and/or over terrains;
(d) Location information of objects within volumes and/or over terrains;
(e) Characterization and/or classification information of objects within volumes and/or over terrains; and/or
(f) Tracking data of objects within volumes and/or over terrains; and
wherein each of the objects within volumes and/or over terrains are at least one of:
(a) Static;
(b) Dynamic;
(c) Inanimate; and/or
(d) Animate.

20. (canceled)

21. (canceled)

22. The method of claim 1, wherein the mapping information is produced using at least one of the following methods:
(a) Analyzing one or more node resultant signals and/or signal attributes and/or medium attributes over time and applying a change detection method. The measured changes in the signal attributes and/or the medium attributes may be employed for object detection, localization, characterization and/or classification purposes;
(b) Applying a forward problem method, using a-priori information and/or certain assumptions regarding the terrain and/or volume;
(c) Applying a forward problem method, using a-priori information and/or certain assumptions regarding the terrain and/or volume, and comparing the measured node resultant signals and/or the signal attributes and/or the medium attributes to computed values;
(d) Iteratively applying a forward problem method, wherein in each step a hypothesized terrain and/or volume map is defined, and the outputs of the forward problem method, when compared to one or more measured node resultant signals and/or signal attributes and/or medium attributes, are used to adjust the hypothesized terrain and/or volume map;
(e) Applying an inverse problem method to one or more measurable physical parameters, such as the local attenuation coefficient and/or the local reflection coefficient and/or spatial location; and/or
(f) Compounding one or more node resultant signals, so as to extract information regarding objects along the signals' paths.

23. The method of claim 22, wherein one or more of the following applies:
(a) The a-priori information includes at least one of:
(i) Information previously produced by systems or methods of the present invention;
(ii) Measurements made by the subject network and/or additional hardware in the subject network's vicinity; and/or
(iii) External information, such as digital terrain model (DTM) and/or digital surface model (DSM) databases;
(b) The forward problem method comprises at least one of the following methods:
(i) Ray tracing; and/or
(ii) Appropriate wave propagation models; and/or
(c) The inverse problem method comprises at least one of the following methods:
(i) Computed tomography;
(ii) Diffraction tomography;
(iii) Microwave tomography; and/or
(iv) Other Hough transform based algorithms.

24. (canceled)

25. (canceled)

26. The method of claim 22, wherein the mapping information is produced using one or more of the following assumptions:
(a) The earliest node resultant signal component, which is still affected by multi-path (“first multi-path signal component”), that is, excluding the component associated with the direct path from the applicable transmitting subject network node to the applicable node signal receiver, is the result of a exactly a single reflection along the signal path; and/or
(b) For the first multi-path signal component of a specific node resultant signal, the possible spatial locations of the reflecting surface producing the first multi-path signal component (“component reflecting surface”) may be defined using at least one of the following criteria:
(i) The component reflecting surface is located over an ellipsoid surface, whose foci correspond to the locations of the applicable transmitting subject network node and the applicable node signal receiver, wherein the ellipsoid is the figure formed from all points whose sum of distances from the two foci equals the measured distance for the first multi-path signal component;
(ii) The measured node resultant signal direction for the first multi-path signal component corresponds to the spatial angle between the component reflecting surface and the node signal receiver; and/or
(iii) In the presence of a non-zero Doppler shift, and assuming that the component reflecting surface is approximately immobile, the path Doppler shift defines a group of allowable spatial angles between the component reflecting surface and the node signal receiver.

27. (canceled)

28. The method of claim 26, wherein the mapping information is produced using first multi-path signal components corresponding to multiple node resultant signals, wherein the possible spatial locations of reflecting surfaces for each of the first multi-path signal components are registered over a three-dimensional space, in a manner similar to that of the Hough transform. Actual reflective surfaces are located where registrations from a relatively high number of first multi-path signal components are present.

29. The method of claim 28, wherein once the first multi-path signal components for two or more of the node resultant signals have been addressed, additional signal components may be analyzed in a similar fashion, using one or more hypotheses regarding the path traversed by each signal component; wherein at least one of the hypotheses regarding the path traversed by each signal component is at least one of the following:
(a) The signal component results from exactly a single reflection along the signal path; and/or
(b) The signal component results from exactly two signal reflections along the signal's path, one of which has already been found in a previous step.

30. (canceled)

31. The method of claim 26, wherein after generating a map of the spatial location of reflective surfaces, their reflection coefficient and/or the attenuation along paths between them are estimated.

32. (canceled)

33. The method of claim 1, wherein the analysis of the one or more of the node resultant signals and/or one or more of the signal attributes further comprises one or more of the following:
(a) Measuring the node resultant signals and/or signal attributes and/or medium attributes at multiple spatial configurations of the transmitting subject network nodes and/or the node signal receivers;
(b) Measuring the node resultant signals and/or signal attributes and/or medium attributes when at least one of the objects within the volume is in different locations;
(c) Classifying of one or more objects within a volume using one or more of the following methods:
(i) Computing object characteristics and comparing them to predefined reference models;
(ii) The presence of a subject network node in immediate proximity to an object may be used as a source of information; and/or
(iii) Volumes wherein certain object types are not expected to be found may be defined, thus reducing false alarms; and/or
(d) Detecting and/or coping with electronic counter measures (ECM), wherein the detecting ECM is performed using at least one of the following methods:
(i) Detection of noise jammers based on their signal pattern as a function of space and/or time; and/or
(ii) Discerning phantom objects, produced by deceptive jammers, from true objects based on self-consistency checks of the signal attributes associated with such objects.

34. (canceled)

35. (canceled)

36. (canceled)

37. (canceled)

38. (canceled)

39. (canceled)

40. (canceled)

41. The method of claim 1, wherein the mapping information is employed for at least one of the following applications:
(a) Security systems, which detect, localize, characterize, classify and/or track objects within volumes and/or over terrains;
(b) Security systems, which detect and/or classify carried objects;
(c) Estimation of the location of people and/or vehicles as a function of time;
(d) Obstacle detection for moving vehicles; and/or
(e) Terrain and/or volume mapping.

42. A system for acquiring information regarding terrain and/or objects within a volume, said system comprising:
a wireless network (“subject network”), including at least two nodes, wherein one or more of the nodes of the subject network (“transmitting subject network nodes”) transmit signals over time (“node signals”);
one or more receiving units (“node signal receivers”), configured to receive the node signals after their traversing a medium (“node resultant signals”); and
one or more processing units (“mapping units”), configured to perform at least the following:
(a) Measure one or more physical attributes (“signal attributes”) for one or more of the node resultant signals, wherein at least one of the signal attributes is of at least one of the following types:
(i) Time difference between node signal transmission by the applicable transmitting subject network node and node resultant signal reception by the applicable node signal receiver;
(ii) Phase difference between the transmitted node signal and the received node resultant signal;
(iii) Power ratio between the transmitted node signal and the received node resultant signal;
(iv) Frequency difference between the received node resultant signal and the transmitted node signal (Doppler shift); and/or
(v) Direction from which the node resultant signal has arrived, and/or its projection on one or more predefined axes;
(b) Estimate the spatial location as a function of time for one or more of the transmitting subject network nodes and/or one or more of the node signal receivers; and
(c) Analyze one or more of the node resultant signals and/or one or more of the signal attributes to extract information regarding objects along the signal's paths (“mapping information”).

43. The system of claim 42, wherein each transmitting subject network node is either mobile or stationary; and
wherein each node signal receiver is either mobile or stationary; and
wherein the subject network is of at least one of the following types:
(a) Wireless personal area network (WPAN);
(b) Wireless local area network (WLAN);
(c) Wireless mesh network:
(d) Wireless Metropolitan area network (wireless MAN);
(e) Wireless wide area network (wireless WAN);
(f) Cellular network or mobile network;
(g) Satellite communications network;
(h) Mobile satellite communications network;
(i) Radio network; and/or
(j) Television network.

44. (canceled)

45. (canceled)

46. The system of claim 42, wherein at least one of the transmitting subject network nodes is either a base station or a mobile phone in a cellular network.

47. (canceled)

48. The system of claim 42, wherein the subject network employs at least one of the following multiple access methods:
(a) Time division multiple access (TDMA);
(b) Frequency division multiple access (FDMA);
(c) Code division multiple access (CDMA); and/or
(d) Orthogonal frequency-division multiple access (OFDMA).

49. The system of claim 42, wherein each node signal receiver is one of:
(a) Associated with a node of the subject network, which may be one of the transmitting subject network nodes or one of the other nodes; or
(b) A sensor configured to measure the node signals and/or the node resultant signals, wherein the sensor may be: (i) passive, only capable of receiving signals transmitted by other elements; or (ii) active, capable of both transmitting and receiving signals.

50. (canceled)

51. (canceled)

52. (canceled)

53. (canceled)

54. (canceled)

55. The system of claim 42, wherein each of the signal attribute measurement and the analysis of the node resultant signals is performed in at least one of the following manners:
(a) Analogically; and/or
(b) Digitally.

56. (canceled)

57. (canceled)

58. (canceled)

59. (canceled)

60. (canceled)

61. (canceled)

62. (canceled)

63. (canceled)

64. (canceled)

65. (canceled)

66. (canceled)

67. (canceled)

68. The system of claim 42, wherein each mapping unit may be at least one of:
(a) A local mapping unit, associated with at least one of the node signal receivers (“local mapping units”); and/or
(b) A central mapping unit, analyzing the outputs of the local mapping units and/or the node resultant signals; and
wherein the signal attribute measurement is performed by at least one of:
(a) One or more of the node signal receivers;
(b) One or more of the local mapping units, associated with applicable node signal receivers; and/or
(c) One or more of the central mapping units.

69. (canceled)

70. The system of claim 42, wherein additional sensors are employed, providing supplementary information to the mapping units.

71. (canceled)

72. The system of claim 42, wherein the system is integrated with at least one of the following systems, providing combined functionality:
(a) Security system;
(b) Surveillance system;
(c) Traffic analysis system;
(d) Obstacle detection system; and/or
(e) Terrain and/or volume mapping system.

73. The method of claim 1, wherein the signal attribute measurement further comprises comparing two or more node resultant signals so as to extract one or more physical attributes, each of which may be relative of absolute; wherein the term “relative physical attributes” refers to the ratio and/or difference between the values of such physical attributes, associated with the two or more node resultant signals.

74. (canceled)

75. The method of claim 22, wherein the compounding one or more node resultant signals is performed using at least one of the following methods:
(a) Interferometry;
(b) Multilateration; and/or
(c) Treating two or more node signal receivers as elements of a receiving array, and applying a beamforming technique to the node resultant signals.
